(19) United States
(12) Patent Application Publication
(10) Pub. No.: US 2016/0366340 A1
(43) Pub. Date: Dec. 15, 2016

(54) PHOTOGRAPHING APPARATUS, PHOTOGRAPHING CONTROLLER, PHOTOGRAPHING CONTROL METHOD, AND PHOTOGRAPHING CONTROL PROGRAM

(71) Applicant: RICOH IMAGING COMPANY, LTD., Tokyo (JP)

(72) Inventors: Teppei OKAMOTO, Tokyo (JP); Masashi MIYATA, Tokyo (JP)

(73) Assignee: RICOH IMAGING COMPANY, LTD., Tokyo (JP)

(21) Appl. No.: 15/161,560

(22) Filed: May 23, 2016

(30) Foreign Application Priority Data
Jun. 12, 2015 (JP) 2015-118808

(51) Int. Cl. H04N 5/232; H04N 5/30; H04N 9/07; H04N 5/225

(52) U.S. Cl. CPC H04N 5/23293; H04N 5/2259; H04N 5/23264; H04N 5/30; H04N 9/07

(57) ABSTRACT

A photographing apparatus includes an image sensor configured to convert an object image formed by a photographing optical system, of the photographing apparatus, into electrical pixel signals, the photographing optical system including an optical element; an imaging controller configured to control an image-capturing process, in which an image set of a plurality of captured images for use in an image-synthesizing operation are captured, wherein, during the image-capturing process, at least one of the image sensor and the optical element is moved to change a relative position between the image sensor and the optical element; and a display controller configured to display the captured images of the image set on a display in accordance with the movement of the at least one of the image sensor and the optical element.

### BACKGROUND OF THE INVENTION

1. Field of the Invention

The present invention relates to a photographing apparatus, a photographing controller, a photographing control method, and a photographing control program.

2. Description of Related Art

In the related art, photographing apparatuses configured to image (photograph) a plurality of images for use in image synthesis have been proposed. For example, in an image-inputting apparatus (i.e., an imaging apparatus, such as a digital camera) disclosed in Japanese Unexamined Patent Publication No. H08-265522, a plurality of images are captured, for use in image synthesis, by capturing images while shifting the position of the optical axis relative to the image sensor in the horizontal and vertical directions. Specifically, image signals for four images, i.e., an image at the origin, an image horizontally shifted by a ½ pixel, an image vertically shifted by a ½ pixel, and an image that is both horizontally and vertically shift by a ½ pixel, which are shifted by optical-axis shift controlling via a lens controller, are stored in a memory, in that order.

This unit of predetermined shift amount that is utilized in this photographing method is in the minute order of pixel units (i.e., a ½ pixel). Accordingly, it is desirable to remove vibrations occurring during a photographing operation, so that an electronic shutter that does not involve any mechanical operations is often used instead of a mechanical shutter that is normally used for photographing operations.

However, in the case where an electronic shutter is used, since no shutter sound occurs, it is very difficult for the user to recognize when the capturing of one set of images has started and ended. Consequently, there is a possibility of the user mistakenly moving the imaging apparatus (e.g., by changing the composition, or removing the imaging apparatus (camera) from a tripod, etc.) even though one set of photographing images is currently being captured. In such a case, the quality of the synthesized image of one set of photographing images becomes significantly deteriorated, resulting in a failed attempt at obtaining a high-quality synthesized image.

### SUMMARY OF THE INVENTION

The present invention has been devised in view of the above-described problem, and provides a photographing apparatus, a photographing controller, a photographing control method, and a photographing control program which enables a user (photographer) to recognize that an image set (a plurality of captured images) are currently being taken (imaged) to prevent the photographing apparatus from being mistakenly (prematurely) moved and to obtain a high-quality synthesized image.

According to an aspect of the present invention, a photographing apparatus is provided, including an image sensor configured to convert an object image formed by a photographing optical system, of the photographing apparatus, into electrical pixel signals, the photographing optical system including an optical element; an imaging controller configured to control an image-capturing process, in which an image set of a plurality of captured images for use in an image-synthesizing operation are captured, wherein, during the image-capturing process, at least one of the image sensor and the optical element is moved to change a relative position between the image sensor and the optical element; and a display controller configured to display the captured images of the image set on a display in accordance with the movement of the at least one of the image sensor and the optical element.

The imaging controller can sequentially move one of the image sensor and the optical element, in a direction that is different to a direction of the optical axis, from a reference position to a plurality of different relative positions, relative to the other of the image sensor and the optical element.

The display controller can displays, on the display, a number of images to be captured that constitute the image set and a number of captured images that have currently already been obtained with each the captured images of the image set.

The display controller can define a plurality of partial screen areas on a display screen of the display, and display the plurality of captured images, obtained at the reference position and at the plurality of different relative positions, at the plurality of partial screen areas, respectively, which correspond to the reference position and the plurality of different relative positions.

The display controller can display information indicating that an image is currently being captured at the partial screen area that corresponds to one of the reference position and the relative positions at which the image is currently being captured.

The display controller can display, at a timing during which the synthesized image is being generated, an animation which shows the plurality of captured images that are respectively displayed at the plurality of partial screen areas consolidating and synthesizing at a predetermined area of the display screen.

The display controller can display the plurality of captured images on the display in a display pattern that corresponds to a pattern of the movement of the at least one of the image sensor and the optical element.

The display controller can display, on the display screen of the display, the plurality of captured images obtained at the reference position and at the plurality of relative positions, so as to partially overlap each other at shifted positions relative to one direction.

The display controller can display, on the display screen of the display, a plurality of translucent images obtained by applying translucent processing on the plurality of captured images obtained at the reference position and at the plurality of relative positions, while overlaying the plurality of translucent images onto each other.

The display controller can display, on the display screen of the display, the obtained the plurality of translucent images so as to overlap each other at shifted positions.

The photographing apparatus can further include a plurality of color filters, including a basic unit of one R pixel, two G pixels and one B pixel, for use in the image-capturing process. Each of the reference position and the plurality of relative positions correspond to each pixel of the basic unit.

In another embodiment, a photographing controller is provided, by which an image set of a plurality of captured images for use in an image-synthesizing operation are captured in a photographing apparatus, whereby at least one of an image sensor and an optical element of the photographing apparatus is moved to change a relative position between the image sensor and the optical element. The photographing controller includes a display controller configured to display, on a display screen of a display, the image set of the plurality of captured images in accordance with the movement of the at least one of the image sensor and the optical element.

In another embodiment, a photographing control method is provided, by which an image set of a plurality of captured images for use in an image-synthesizing operation are captured in a photographing apparatus, whereby at least one of an image sensor and an optical element of the photographing apparatus is moved to change a relative position between the image sensor and the optical element. The photographing control method includes displaying, on a display screen of a display, the image set of the plurality of captured images in accordance with the movement of the at least one of the image sensor and the optical element.

In another embodiment, a photographing control program is provided, to be implemented by a processor, which performs a process which displays, on a display screen of a display, an image set of a plurality of captured images for use in an image-synthesizing operation in accordance with a movement of at least one of an image sensor and an optical element provided in a photographing apparatus, while changing a relative position between the image sensor and the optical element.

According to the present invention, a photographing apparatus, a photographing controller, a photographing control method, and a photographing control program are achieved which enables a user (photographer) to recognize that an image set (a plurality of captured images) are currently being taken (imaged) to prevent the photographing apparatus from being mistakenly (prematurely) moved and thereby obtain a high-quality synthesized image.

The present disclosure relates to subject matter contained in Japanese Patent Application No. 2015-118808 (filed on Jun. 12, 2015) which is expressly incorporated herein in its entirety.

### BRIEF DESCRIPTION OF THE DRAWINGS

The present invention will be discussed below in detail with reference to the accompanying drawings, in which:

FIG. 1 is a block diagram indicating the main components of a digital camera (photographing apparatus) of a first embodiment according to the present invention;

FIG. 2 is a block diagram indicating the main components of an image-shake correction device (image stabilizer);

FIG. 3 is a side elevational view showing an arrangement of the image-shake correction device;

FIG. 4 is a functional, block diagram indicating an internal configuration of a DSP (controller);

FIGS. 5A, 5B, 5C and 5D are conceptual diagrams of an example of a “PSR photographing mode” of the illustrated embodiment;

FIG. 6 is an explanatory diagram of a process performed by the digital camera of the first embodiment;

FIG. 7 is a timing chart showing an example of a timing of the process performed by the digital camera of the first embodiment;

FIG. 8 is an explanatory diagram of a process performed by the digital camera of the second embodiment;

FIG. 9 is a timing chart showing an example of a timing of the process performed by the digital camera of the second embodiment;

FIG. 10 is an explanatory diagram of a process performed by the digital camera of the third embodiment; and

FIG. 11 is a timing chart similar to that of FIG. 7 and shows an explanatory diagram of a process performed by the digital camera of the fourth embodiment.

### DESCRIPTION OF THE EMBODIMENTS

A detailed explanation of embodiments of a photographing apparatus, a photographing controller, a photographing control method, and a photographing control program will be herein discussed with reference to the drawings. However, the present invention is not limited to the following disclosed embodiments of the photographing apparatus, the photographing controller, the photographing control method, and the photographing control program. In the embodiments, components sharing the same function are indicated with common designators, and duplicate explanations thereof have been omitted.

### Embodiment 1

### [Example Configuration of Imaging Apparatus (Photographing Apparatus)]

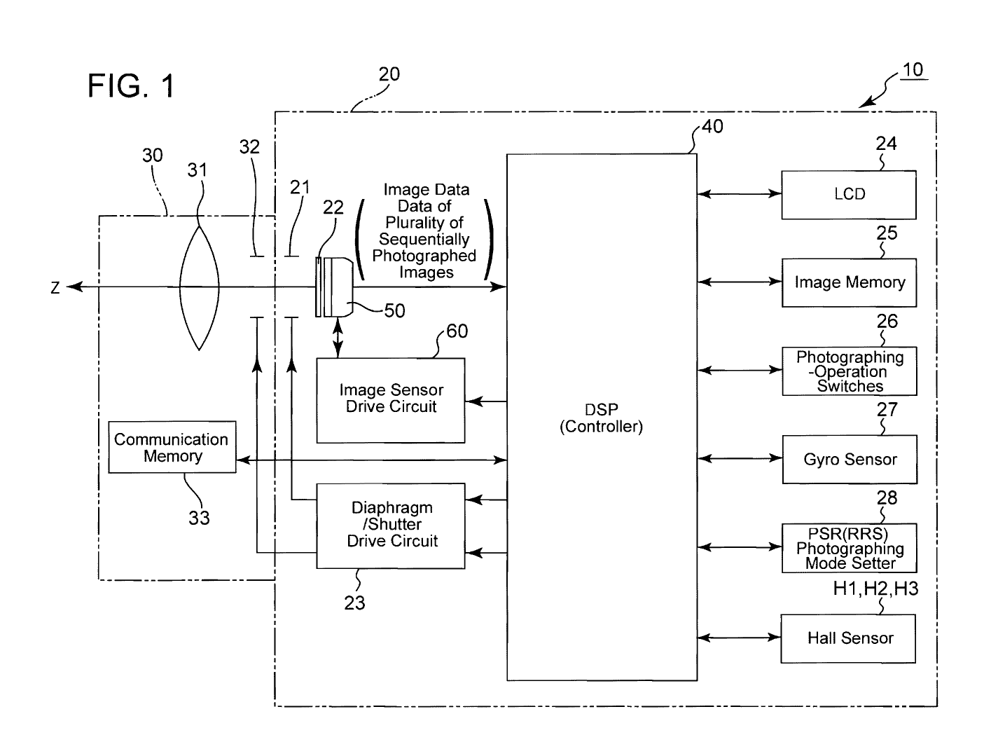

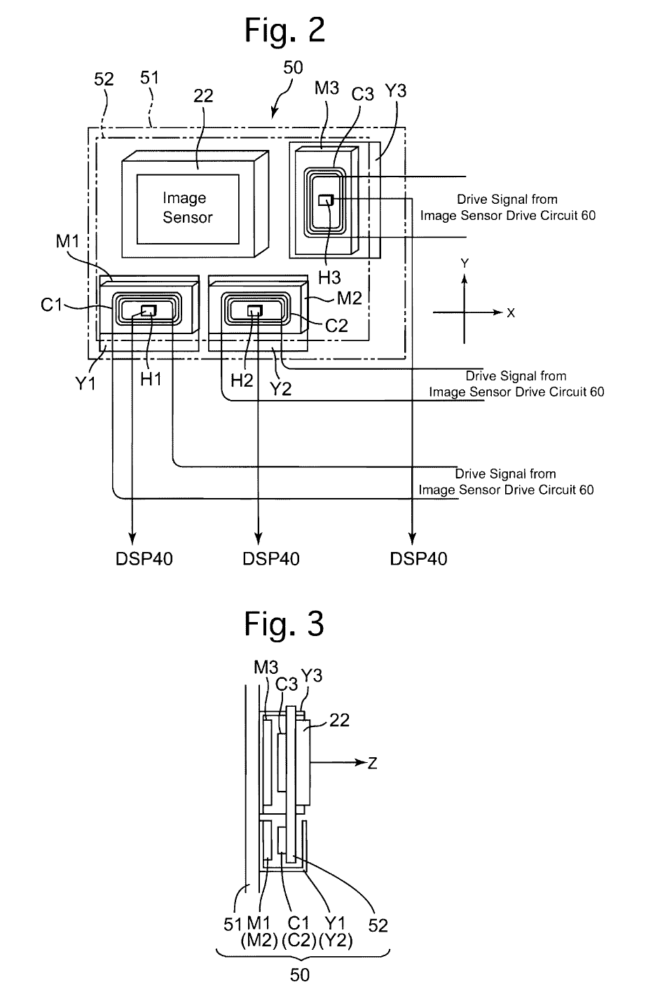

FIG. 1 is a block diagram indicating the main components of a digital camera (photographing apparatus) 10 of a first embodiment according to the present invention. FIG. 2 is a block diagram indicating the main components of an image-shake correction device. FIG. 3 is a side elevational view showing an arrangement of the image-shake correction device.

As shown in FIG. 1, the digital camera 10 is provided with a camera body 20, and a photographing lens 30 (an interchangeable photographing lens) which is detachably attached to the camera body 20. The photographing lens 30 is provided with a photographing lens group (part of a photographing optical system/movable member/image-shake correction member) 31, and a diaphragm (part of the photographing optical system) 32, in that order from the object side (left side of FIG. 1) to the image side (right side of FIG. 1). The camera body 20 is provided with a shutter (part of the photographing optical system) 21, and an image sensor (movable member/image-shake correction member) 22, in that order from the object side (left side of FIG. 1) to the image side (right side of FIG. 1). Furthermore, the camera body 20 is provided with a diaphragm/shutter drive circuit 23 which controls the driving of the diaphragm 32 and the shutter 21 when the photographing lens 30 is attached to the camera body 20. An object image, which is formed by object-emanating light. rays that are incident on the photographing lens group 31 and pass through the diaphragm 32 and the shutter 21, is formed on a light-receiving surface of the image sensor 22. The object image which is formed on the light-receiving surface of the image sensor 22 is electrically converted into pixel signals via a large number of pixels, arranged in a matrix, having different detection colors, and is output as image data (plurality of sequentially photographed image data) to a DSP (Digital Signal Processor/controller/processor) 40. The DSP 40 performs predetermined image processing on image data that has been input therein from the image sensor 22; and this processed image data is displayed on an LCD (display) 24 and is stored in an image memory 25. Furthermore, although the photographing lens group 31 is indicated in FIG. 1 as a single lens element, in practice the photographing lens group 31 includes a plurality of lens elements such as, e.g., a fixed lens element (s), lens elements of a zoom lens system which move during zooming, and/or a focusing lens element (s) which moves during focusing, etc.

Although not shown in the drawings, the image sensor 22 is configured of a plurality of components, such as a package, a solid-state imaging device chip accommodated in the package, and a lid member fixed onto the package in order to protect the solid-state imaging device chip in an air-tight manner. In the present disclosure, “driving the image sensor 22” refers to “driving at least a part of the plurality of components of the image sensor 22 through which the object-emanating light rays pass”.

The photographing lens 30 is provided with a communication memory 33 which stores various information, such as resolution (MTF) information of the photographing lens group 31 and the aperture diameter (aperture value) of the diaphragm 32, etc. Upon the photographing lens 30 being attached to the camera body 20, various information stored in the communication memory 33 is read into the DSP 40.

The camera body 20 is provided with photographing-operation switches 26 which are connected to the DSP 40. The photographing-operation switches 26 include various switches, such as a power-ON switch and a shutter-release switch, etc.

The camera body 20 is further provided with a gyro sensor (shake detector) 27 which is connected to the DSP 40. The gyro sensor 27 detects shake detection signals that indicate shaking in a plane that is orthogonal to the optical axis (the optical axis that is defined by the photographing lens group 31) within the camera body 20 by detecting the angular velocity of the movement that is applied to the camera body 20 (about an x-axis and a y-axis).

As shown in FIGS. 1 through 3, the image sensor 22 is mounted onto an image-shake correction device (image stabilizer) 50 so that the image sensor 22 is movable in an x-direction and a y-direction (two orthogonal directions), which are orthogonal to an optical axis Z of the photographing optical system (photographing lens group 31). The image-shake correction device 50 is provided with a mount support plate 51 which is mounted onto a structural member such as a chassis, etc., of the camera body 20; a movable stage 52, onto which the image sensor 22 is mounted, which is slidable relative to the mount support plate 51; magnets M1, M2 and M3 mounted onto the mount support plate 51 on the side thereof that faces the movable stage 52; yokes Y1, Y2 and Y3 which are made of a magnetic material and are mounted onto the mount support plate 51 to face the magnets M1, M2 and M3 with the movable stage 52 positioned between the magnets M1, M2 and M3 and the yokes Y1, Y2 and Y3, thereby forming a magnetic circuit between the yokes Y1, Y2 and Y3 and the magnets M1, M2 and M3, respectively; and drive coils C1, C2 and C3, mounted onto the movable stage 52, which each generate a driving force by receiving en electric current within the magnetic field of the magnetic circuit. The movable stage 52 (image sensor 22) is driven (moved) relative to the mount support plate 51 within a plane that is orthogonal to the optical axis by supplying (applying) alternating drive signals (alternating current) to the drive coils C1, C2 and C3. The alternating drive signals that are supplied to the drive coils C1, C2 and C3 are controlled by the DSP 40 and are generated by an image sensor drive circuit 60.

In the illustrated embodiment, a magnetic driver configured of the magnet M1, the yoke Y1 and the drive coil C1, and a magnetic driver configured of the magnet M2, the yoke Y2 and the drive coil C2 (two magnetic drivers) are arranged along a long-side direction (horizontal direction/x-direction) of the image sensor 22 at a predetermined distance therebetween; and a magnetic driver configured of the magnet M3, the yoke Y3 and the drive coil C3 (one magnetic driver) is arranged along a short-side direction of the image sensor 22 orthogonal to the long-side direction thereof (vertical direction/y-direction).

The mount support plate 51 is further provided with Hall sensors (position detectors) H1, H2 and H3 arranged in the close vicinity of the drive coils C1, C2 and C3, respectively (within the central spaces thereof). The Hall sensors H1, H2 and H3 detect the magnetic force of the magnets M1, M2 and M3 and output (detect) Hall output signals (position detection signals), which indicate the position of the movable stage 52 (image sensor 22) in a plane that is orthogonal to the optical axis Z. The y-directional position and inclination (rotation) of the movable stage 52 (image sensor 22) are detected by the Hall sensors H1 and H2, and the x-directional position of the movable stage 52 (image sensor 22) is detected by the Hall sensor H3. The DSP 40 controls, via the image sensor drive circuit 60, the driving of the image-shake correction device 50, which moves the image sensor 22 within a plane orthogonal to the optical axis Z, based on shake detection signals detected by the gyro sensor 27 that indicate hand shake/vibrations applied to the camera body 20 in a plane orthogonal to the optical axis Z, and the Hall output signals that indicate the position of the image sensor 22 within a plane orthogonal to the optical axis Z output by the Hall sensors H1, H2 and H3. Accordingly, the imaging position of the object image on the image sensor 22 can be displaced to correct image shake that is caused by hand shake/vibrations, etc.

The digital camera 10 of the illustrated embodiment is provided with a photographing mode (multi-shot mode) which sequentially takes a plurality of pictures (images) while utilizing the image-shake correction device 50 to minutely move the image sensor 22 in a plane that is orthogonal to the optical axis Z of the photographing optical system (photographing lens group 31), and synthesizes these images into a single picture (synthesized not by simple addition of the images, but by synthesizing using specific arithmetic operations via image processing of data), thereby generating an ultra-high definition (high picture quality and high precision) image; hereinafter, this photographing mode will be referred to as a “PSR (Pixel Shift Resolution) photographing mode” (Pixel Shift Resolution is also known as “RRS (Real Resolution System)”. As shown in FIG. 1, the camera body 20 is provided with a PSR photographing mode setter 28, connected to the DSP 40, for determining whether or not to carry out a “PSR photographing mode”, and also for performing detailed settings.

Unlike a conventional Bayer method that obtains one piece of color information per one pixel, the “PSR photographing mode (multi-shot mode)” obtains information of each RGB color for each pixel, thereby enabling an extremely high definition image to be created that has superior detail and color reproduction. Furthermore, an effect can be obtained in which high sensitivity noise can be reduced without the occurrence of moiré or false color.

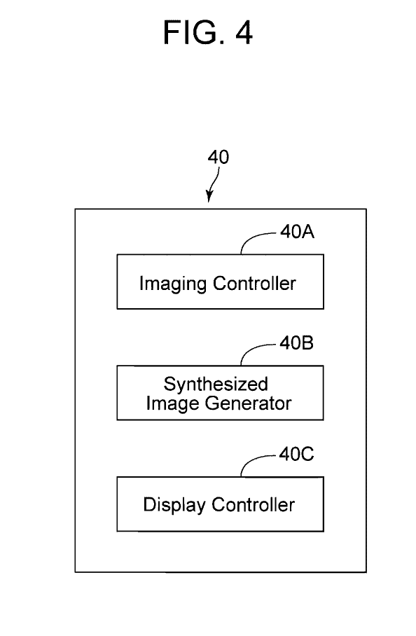

FIG. 4 is a functional block diagram indicating an internal configuration of a DSP (controller) 40. in FIG. 4, the DSP (controller) 40 includes an imaging controller 40A, a synthesized-image generator 40B, and a display controller (processor) 400.

The imaging controller 40A controls an “imaging process” in which a “set of images”, configured of a plurality of captured images for use in multi-shot image synthesis, are captured. In this “imaging process”, one of the image sensor 22 and an optical element provided in the photographing optical system (e.g., at least part of the photographing lens group 31) moves relative to the other of the image sensor 22 and the optical element provided in the photographing optical system, in a sequential order, to respectively plurality of different “relative positions” in a direction that is different to a direction of the optical axis (e.g., in directions that are orthogonal to the optical axis) from a “reference position” of the one of the image sensor 22 and the optical element provided in the photographing optical system (e.g., at least part of the photographing lens group 31) relative to the other of the image sensor 22 and the optical element provided in the photographing optical system. The term “optical element” used herein can refer to a lens group (or lens element), a prism or a mirror.

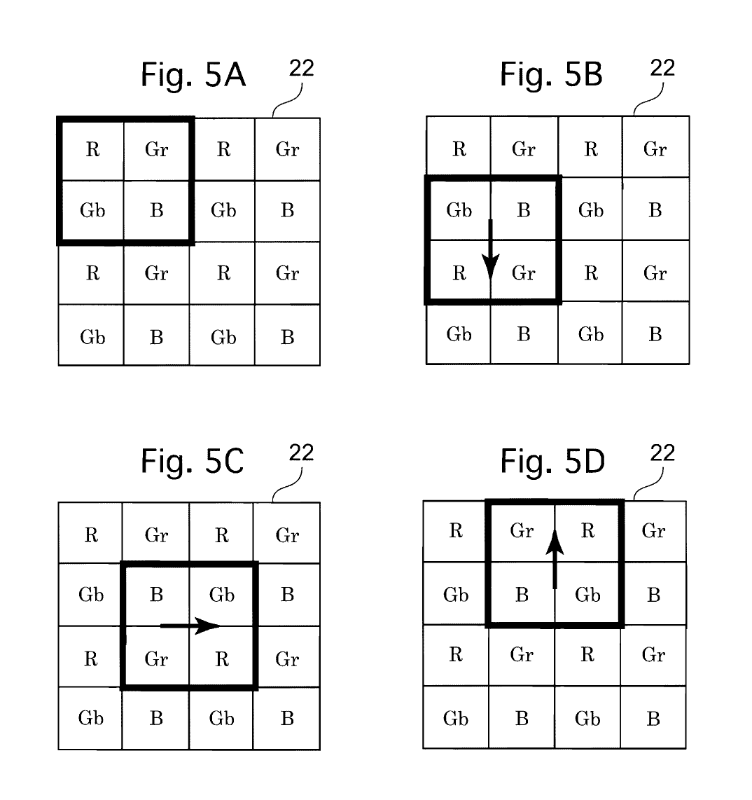

FIGS. 5A through 5D are conceptual diagrams of an example of a “PSR photographing mode (multi-shot mode)” of the illustrated embodiment. In each of FIGS. 5A through 5D, the image sensor 22 is provided with a large number of pixels arranged at a predetermined pixel pitch as a matrix on the light-receiving surface of the image sensor 22, and one of Bayer array color filters R, G (Gr, Gb) and B is provided in front surface of each pixel. In particular, the Bayer array color filters, one R pixel, two G pixels and one B pixel are included as a “basic unit”. The pixels detect the color of the object-emanating light rays that are incident thereon, i.e., photoelectrically convert the light of the color components (color band), via the respective color filters R, G (Gr, Gb) and B (which are provided on the front surface of the pixels), and each pixel stores an electrical charge in accordance with the strength (luminance) of the light rays. More specifically, an image is photographed at the reference position shown in FIG. 5A; another image is photographed at the position shown at FIG. 5B, at which the image sensor 22 has been moved (relatively shifted) downward by a pitch of one pixel; another image is photographed at the position shown at FIG. 5C, at which the image sensor 22 has been further moved rightward by a pitch of one pixel; another image is photographed at the position shown at FIG. 5D, at which the image sensor 22 has been further moved upward by a pitch of one pixel; and thereafter the image sensor 22 returns to the reference position shown in FIG. 5A. In other words, in the present specification, e.g., the position which is indicated in FIG. 5A is referred to as the “reference position”, and the positions which are indicated in FIGS. 5B through 5D are referred to as “relative positions”. Furthermore, the “reference position” and the plurality of “relative positions” respectively correspond to the four pixels of the above-mentioned “basic unit” (i.e., one R pixel, two G pixels and one B pixel). Hence, four images that are sequentially photographed by driving the image sensor 22, in a square movement path at a pitch of one pixel in a plane that is orthogonal to the optical axis, are input into the DSP 40 as raw image data (raw format data).

Returning to FIG. 4, the synthesized-image generator 40B generates a synthesized image using the set of images obtained at the stage where all the constituent images of the set of images are obtained by the imaging controller 40A.

The display controller 40C performs a “display control process”. As an example of a “display control process”, the display controller 40C controls a displaying of a plurality of captured images captured at the reference position and at the plurality of relative positions, respectively, onto the LCD (display) 24 in accordance with the “relative shift” (the relative movement of one of the image sensor 22 and the aforementioned optical element provided in the photographing optical system). “Accordance with the relative shift” refers to, e.g., with respect to timing, displaying the captured image captured at the first position at the timing itself of the shifting from the first position to the subsequent second position, and at a predetermined timing of the photographing process at the second position and/or of the imaging process. In other words, since it is only required to display the captured image captured at the first position at a timing that has a predetermined relationship with the timing of the shifting from the first position to the subsequent second position, “accordance with the relative shift” also includes the concept of “displaying in synchronization with the relative shift”. Furthermore, the display controller 40C can control the LCD 24 to display the captured images in a manner that is recognizable to the user, e.g., by displaying the number of captured images that constitute the set of images and the number of captured images that have currently already been obtained.

For example, in the first embodiment, the display controller 40C defines a plurality of “partial screen areas” with respect to a display screen of the LCD 24. Furthermore, the display controller 40C makes the plurality of “partial screen areas” to correspond to the reference position and the plurality of relative positions, respectively. In other words, e.g., each “partial screen area” on the display screen of the LCD 24 is compatible with the pixels, which each has the “basic unit” of the above-described color filters. Furthermore, the display controller 40C displays the plurality of captured images, obtained at the reference position and at the plurality of relative positions, in the partial screen areas, respectively, which correspond to the reference position and the plurality of relative positions.

Furthermore, the display controller 40C performs a “display control process” by displaying information indicating “image synthesis in progress” in the LCD 24 during the period (time interval) when image synthesis is being carried out by the synthesized-image generator 40B. Thereafter, upon the image synthesizing process in the synthesized-image generator 40B ending, the display controller 40C displays a synthesized image as a “display control process”. Details of the operations involved in this “display control process” will be described hereinbelow.

### [Example Operation of Imaging Apparatus]

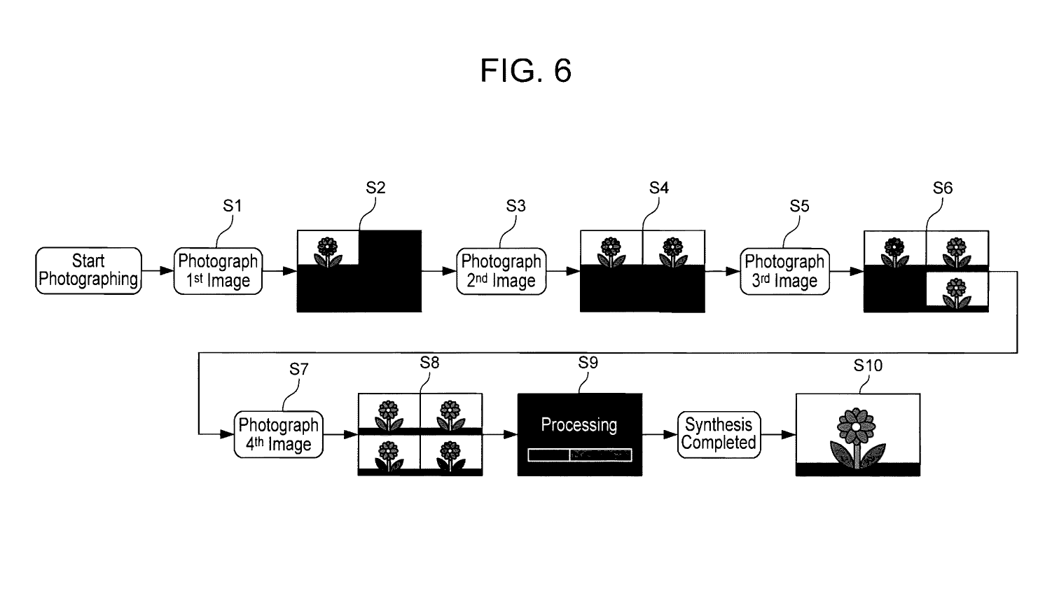

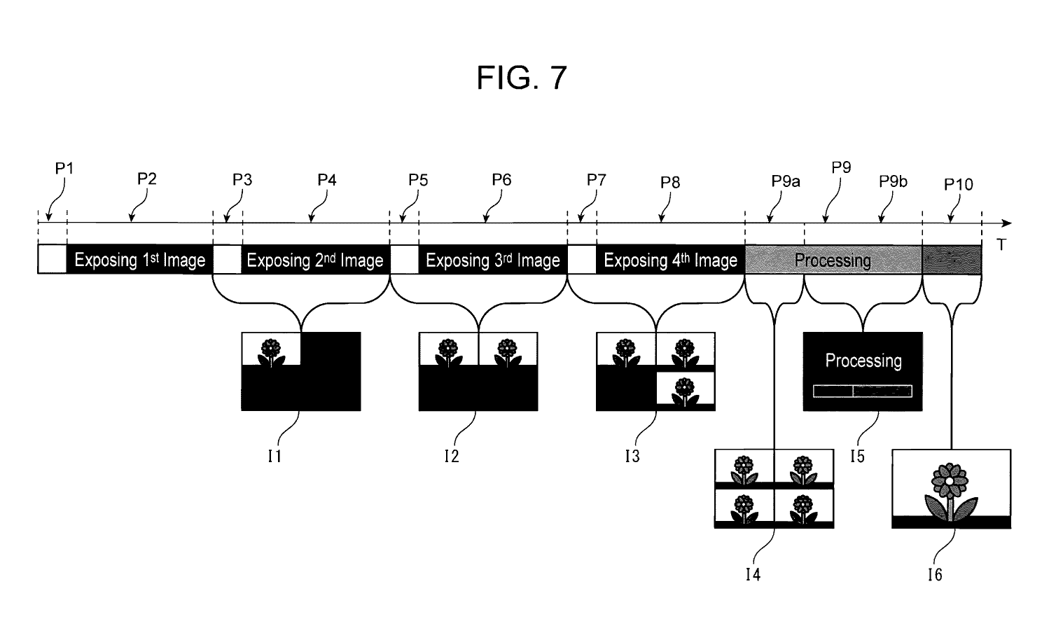

The following is a description of an example of a process performed by the digital camera (imaging apparatus) 10, which is provided with the above-described configuration. FIG. 6 is an explanatory diagram of the process performed by the digital camera 10 of the first embodiment. FIG. 7 is a timing chart showing an example of a timing of the process performed by the digital camera of the first embodiment. The operations in FIGS. 6 and 7 indicate a process performed in the DSP 40; this process is performed by the DSP 40 reading out a control program stored in a memory (not shown). Furthermore, the digital camera 10 performs the multi-shot mode photographing operation via an electronic shutter operation with the shutter 21 fully open.

In step S1 (indicated in FIG. 6), the imaging controller 40A of the DSP 40 controls the photographing of a first image at the reference position (i.e., the position shown in FIG. 5A). As shown, for example, FIG. 7, the imaging controller 40A controls a photographing preliminary operation during an interval (time interval) P1, and controls an exposure (photographing operation) during an interval (time interval) P2. During the interval P2, although not shown in FIG. 7, upon a predetermined exposure time elapsing, an image signal is read out from the image sensor 22 and a developing process per image unit (frame unit) of the captured image obtained at the reference position is carried out. It should be noted that at this stage, since a captured image cannot be obtained at the intervals P1 and P2 during which a photographing operation (including the photographing preliminary operation and an exposure operation) is carried out at the reference position, it is assumed that nothing is displayed on the LCD 24 (i.e., is in a “blacked out” state). Furthermore, the photographing preliminary operation during the interval P1 can include a shutter fully-opening operation, a photometering operation, an exposure-value (exposure time and aperture value) setting operation and/or an AF operation.

At step S2, upon the photographing operation at the reference position ending, the display controller 40C displays the captured image (developed image) obtained at the reference position on the LCD 24 at the partial screen area thereof that corresponds to the reference position. In other words, e.g., a display image I1 shown in FIG. 7 is displayed on the LCD 24. At step S3, the imaging controller 40A controls the image sensor 22 and the aforementioned optical element (e.g., the photographing lens group 31) to relatively shift to the first relative position (i.e., the position shown in FIG. 5B), and controls the photographing operation for the-second image at the first relative position. For example, as shown in FIG. 7, the imaging controller 40A controls the photographing preliminary operation (including a relative shift) during an interval (time interval) P3, controls an exposure during an interval (time interval) P4, and develops a captured image that is obtained at the first relative position. Furthermore, from the time the exposure of the first image is completed until the exposure of the second image is completed (intervals P3 and P4), the first captured image obtained at the reference position is displayed on the LCD 24 at the partial screen areas thereof that corresponds to the reference position, as described above.

At step S4, upon the photographing operation at the first relative position ending, the display controller 40C displays the captured image (developed image) obtained at the first relative position on the LCD 24 at the partial screen area thereof that corresponds to the first relative position. In other words, e.g., a display image I2 shown in FIG. 7 is displayed on the LCD 24. At step S5, the imaging controller 40A controls the image sensor 22 and the aforementioned optical element (e.g., the photographing lens group 31) to relatively shift to the second relative position (i.e., the position shown in FIG. 5C), and controls the photographing operation for the third image at the second relative position. For example, as shown in FIG. 7, the imaging controller 40A controls the photographing preliminary operation (including a relative shift of the image sensor 22) during an interval (time interval) P5, controls an exposure during an interval (time interval) P6, and develops a captured image that is obtained at the second relative position. Furthermore, from the time the exposure of the second image is completed until the exposure of the third image is completed (intervals P5 and P6), the second captured image obtained at the first relative position is displayed on the LCD 24 at the partial screen area thereof that corresponds to the first relative position, as described above.

At step S6, upon the photographing operation at the second relative position ending, the display controller 40C displays the captured image (developed image) obtained at the second relative position on the LCD 24 at the partial screen area thereof that corresponds to the second relative position. In other words, e.g., a display image I3 shown in FIG. 7 is displayed on the LCD 24. At step S7, the imaging controller 40A controls the image sensor 22 and the aforementioned optical element (e.g., the photographing lens group 31) to relatively shift to the third relative position (i.e., the position shown in FIG. 5D), and controls the photographing operation for the fourth image at the third relative position. For example, as shown in FIG. 7, the imaging controller 40A controls the photographing preliminary operation (including a relative shift of the image sensor 22) during an interval (time interval) P7, controls an exposure during an interval (time interval) P8, and develops a captured image that is obtained at the third relative position. Furthermore, from the time the exposure of be third image is completed until the exposure of the fourth image is completed (intervals P7 and P8), the third captured image obtained at the second relative position is displayed on the LCD 24 at the partial screen area thereof that corresponds to the second relative position, as described above.

At step S8, upon the photographing operation at the third relative position ending, the display controller 40C displays the captured image (developed image) obtained at the third relative position on the LCD 24 at the partial screen area thereof that corresponds to the third relative position. In other words, e.g., a display image I4 shown in FIG. 7 is displayed on the LCD 24. At step S9, the synthesized-image generator 40B generates a synthesized image using the four captured images obtained at the reference position and the first through third relative positions For example, as shown in FIG. 7, the synthesized-image generator 40B carries out an image-synthesizing operation at an interval (time interval) P9. In addition, as shown in FIG. 7, during a first segment of the interval P9, i.e., P9a, the display controller 40C displays the display image I4, which shows the four captured images obtained at the reference position and the first through third relative positions at the partial screen areas thereof, respectively. During an interval P9b, which follows the interval P9a, a display image I5 which includes information indicating that an image-synthesizing operation is in progress is displayed on the LCD 24. The display image I5 can, for example, display information that enables the user to recognize the current progress of the image-synthesizing operation by indicating a horizontal bar that becomes increasingly longer in accordance with the amount of progress of the image-synthesizing operation in order to show that the image-synthesizing operation is currently in progress. Note that the display image I4 may continue to be displayed during the interval P9b after the interval P9a in the same manner as that during the interval P9a.

At step S10, upon the image-synthesizing operation ending, the display controller 40C displays the generated synthesized image on the LCD 24. For example, as shown in FIG. 7, a display image I6 of the synthesized image is displayed on the LCD 24 during the interval P10.

The display controller 40C of the first embodiment sequentially displays the four capture images, obtained at the reference position and the three relative positions, in the same pattern (display pattern) as a “relative shift pattern” that is controlled by the imaging controller 40A. In other words, the display image sequentially changes by each still image that is captured at each position being sequentially added to the display in accordance with the shifting (movement) of one of the image sensor 22 and the aforementioned optical element (e.g., the photographing lens group 31). For example, if the “relative shift pattern” shown in FIGS. 5A through 5D shifts in a clockwise direction, the display controller 40C sequentially displays the four captured images obtained at the reference position and the three relative positions in a clockwise manner, with respect to the four partial screen areas, into which the display screen of the LCD 24 is divided. The above-described “display pattern” is not limited thereto, and can be a pattern, e.g., that matches the shifting direction of the image sensor 22 and sequentially displays the four captured images obtained at the reference position and the first through third relative positions in an anti-clockwise manner. Alternatively, the “display pattern” can be a pattern which sequentially displays the four captured images, obtained at the reference position and the first through third relative positions, so that the path of the display positions plots a “Z” pattern. In other words, the “display pattern” can be the same as that of a display pattern that is used when a plurality of images are shown reduced in size (e.g., in the case where the display screen is divided into 3 rows by 3 columns, a display pattern in which the captured images are sequentially displayed at the first row from left to right, thereafter transfers to the second row and the captured images sequentially displayed from left to right, and thereafter transfers to the third row and the capture images are sequentially displayed at the third row from left to right). Alternatively, the “display pattern” can be a pattern such that the four captured images obtained at the reference position and the first through third relative positions with respect to the four partial screen areas (which constitutes the display screen of the LCD 24 vertically and horizontally divided into four sections) are sequentially displayed, e.g., from the top (bottom) or from the right (left).

As described above, according to the first embodiment, in the DSP 40, the display controller 40C synchronizes a plurality of captured images captured at the reference position and the at the plurality of relative positions, respectively, with the “relative shift”, and the plurality of captured images respectively displayed on the LCD 24.

According to the configuration of the DSP 40, even if an electronic shutter is used in imaging processing of a multi-shot mode, the user can recognize when the capturing of one set of images has started and ended. Accordingly, the possibility of the user moving the photographing apparatus during capturing of a set of images is decreased, so that the picture quality of the one set of captured images, and in turn the synthesized image, can be improved.

For example, the display controller 40C defines a plurality of partial screen areas on the display screen of the LCD 24, and the plurality of captured images obtained at the reference position and the first through third relative positions are sequentially displayed at the plurality of partial screen areas, which correspond to the reference position and the first through third relative positions.

According to the above-described configuration of the DSP 40, the amount of progress of the imaging process of the multi-shot mode can be reliably recognized by the user.

Furthermore, the display controller 40C can, e.g., display a plurality of captured images on the LCD 24 in a display pattern that corresponds to a pattern of the relative shift of the image sensor 22 and/or the aforementioned optical element (e.g., the photographing lens group 31).

According to the above-described configuration of the DSP 40, in an arrangement in which the progress matches the movement of the multi-shot operation, the amount of progress of the imaging process of the multi-shot mode can be reliably recognized by the user. In other words, the user can artificially discern the path of movement of the movable member (at least one of the image sensor 22 and the aforementioned optical element) during a multi-shot process.

### Modified Embodiment

The display controller 40C can, alternatively, display an animation, as a “display image including information indicating that an image-synthesizing operation is in progress”, by showing the plurality of captured images that are respectively displayed at the plurality of partial screen areas consolidating and synthesizing at a predetermined area (e.g., at the central area) of the display screen of the LCD 24.

### Embodiment 2

In the second embodiment, “information indicating that an image is currently being captured” is displayed at the partial screen area that corresponds to either the reference position or one of the relative positions at which an image is currently being captured, and this partial screen area is not in a blacked out state like in that case of the first embodiment

[Example Configuration of imaging Apparatus]

In the digital camera (imaging apparatus) 10 of the second embodiment, the display controller 40C displays “information indicating that an image is currently being captured” at the partial screen area that corresponds to the position of the image that is currently being captured out of the reference position and the plurality of relative positions. For example, the display controller 40C displays a gray colored “camera mark” at the partial screen area that corresponds to the position of the image that is currently being captured out of the reference position and the plurality of relative positions. It should be noted that the color of the “camera mark” is not limited to gray; the manner by which the “camera mark” is displayed only needs to be different from the background of the display.

### [Example Operation of Imaging Apparatus]

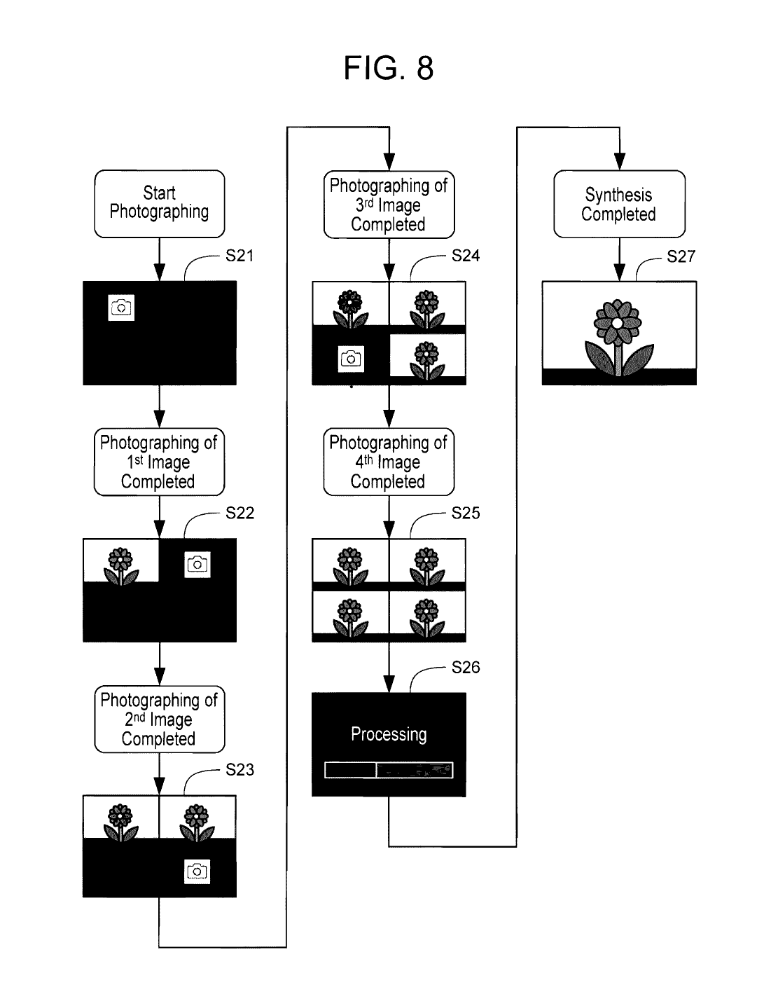

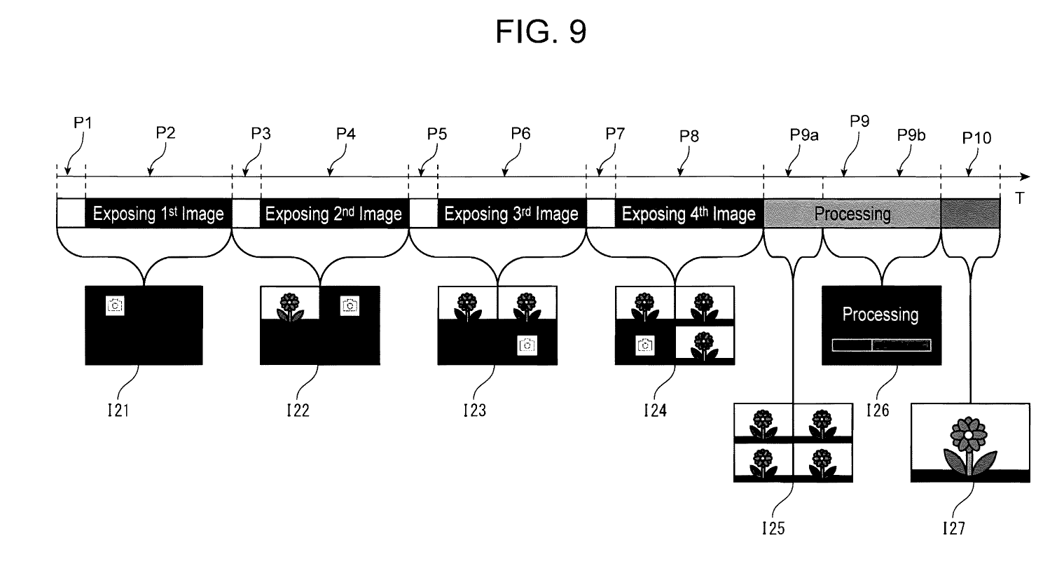

The following is a description of an example of a process performed by a digital camera (imaging apparatus) 10 of the second embodiment, which is provided with the above-described configuration. FIG. 8 is an explanatory diagram of the process performed by the digital camera 10 of the second embodiment. FIG. 9 is a timing chart showing an example of a timing of the process performed by the digital camera of the second embodiment.

In step S21 (indicated in FIG. 8), the imaging controller 40A of the DSP 40 controls the photographing of a first image at the reference position (i.e., the position shown in FIG. 5A). Furthermore, at step 21, the display controller 40C displays a “camera mark” at the partial screen area that corresponds to the reference position (i.e., the position shown in FIG. 5A). For example, as shown in FIG. 9, a display image I21 showing a “camera mark” is displayed in the partial screen area that corresponds to the reference position during intervals P1 and P2.

At step S22, upon the photographing operation at the reference position ending, the imaging controller 40A controls the image sensor 22 and the aforementioned optical element (e.g., the photographing lens group 31) to relatively shift to the first relative position (i.e., the position shown in FIG. 5B), and controls the photographing operation for the second image at the first relative position. Furthermore, at step S22, the display controller 40C displays the captured image (developed image) obtained at the reference position on the LCD 24 at the partial screen area thereof that corresponds to the reference position and displays a “camera mark” at the partial screen area that corresponds to the first relative position at which an image is currently being captured. For example, as shown in FIG. 9, during intervals P3 and P4, a captured image obtained at the reference position is displayed at the partial screen area that corresponds to the reference position, and a display image I22 showing a “camera mark” is displayed in the partial screen area that corresponds to the first relative position, at which an image is currently being captured.

At step S23, upon the photographing operation at the first relative position ending, the imaging controller 40A controls the image sensor 22 and the aforementioned optical element (e.g., the photographing lens group 31) to relatively shift to the second relative position (i.e., the position shown in FIG. 5C), and controls the photographing operation for the third image at the second relative position. Furthermore, at step S23, the display controller 40C displays the captured image (developed image) obtained at the first relative position on the LCD 24 at the partial screen area thereof that corresponds to the first relative position and displays a “camera mark” at the partial screen area that corresponds to the second relative position at which an image is currently being captured. For example, as shown in FIG. 9, during intervals P5 and P6, a captured image obtained at the first relative position is displayed at the partial screen area that corresponds to the first relative position and a display image I23 showing a “camera mark” is displayed in the partial screen area that corresponds to the second relative position, at which an image is currently being captured.

At step S24, upon the photographing operation at the second relative position ending, the imaging controller 40A controls the image sensor 22 and the aforementioned optical element (e.g., the photographing lens group 31) to relatively shift to the third relative position (i.e., the position shown in FIG. 5D), and controls the photographing operation for the fourth image at the third relative position. Furthermore, at step S24, the display controller 40C displays the captured image (developed image) obtained at the second relative position on the LCD 24 at the partial screen area thereof that corresponds to the second relative position and displays a “camera mark” at the partial screen area that corresponds to the third relative position at which an image is currently being captured. For example, as shown in FIG. 9, during intervals P7 and P8, a captured image obtained at the second relative position is displayed at the partial screen area that corresponds to the second relative position and a display image I24 showing a “camera mark” is displayed in the partial screen area that corresponds to the third relative position, at which an image is currently being captured.

At step S25, upon the photographing operation at the third relative position ending, the synthesized-image generator 40B generates a synthesized image using the four captured images obtained at the reference position and the first through third relative positions. Furthermore, at step S25, the display controller 40C further displays the captured image (developed image) obtained at the third relative position on the LCD 24 at the partial screen area thereof that corresponds to the third relative position. For example, during the interval P9a, a display image I25, which shows the four captured images obtained at the reference position and the first through third relative positions at the partial screen areas thereof, respectively, is displayed.

At step S26, the display controller 40C displays, on the LCD 24, information indicating that an image-synthesizing operation is in progress. For example, as shown in FIG. 9, during the interval P9b, a display image I26 is displayed which includes information that indicates that the image-synthesizing operation is currently in progress.

At step S27, upon the image-synthesizing operation ending, the display controller 40C displays the generated synthesized image on the LCD 24. For example, as shown in FIG. 9, a display image I27 of the synthesized image is displayed on the LCD 24 during the interval P10.

As described above, according to the second embodiment, in the DSP 40 the display controller 40C displays “information indicating that an image is currently being captured” at the partial screen area that corresponds to either the reference position or one of the relative positions at which an image is currently being captured.

According to the configuration of the DSP 40, even if an electronic shutter is used in imaging processing of a multi-shot mode, the user can reliably recognize which image number (e.g., the first, second, third or fourth image) out of the set of images is currently being photographed.

### Embodiment 3

The third embodiment describes a variation in the displaying method of displaying a plurality of captured images obtained at the reference position and at the above-described plurality of relative positions.

### [Example Configuration of Imaging Apparatus]

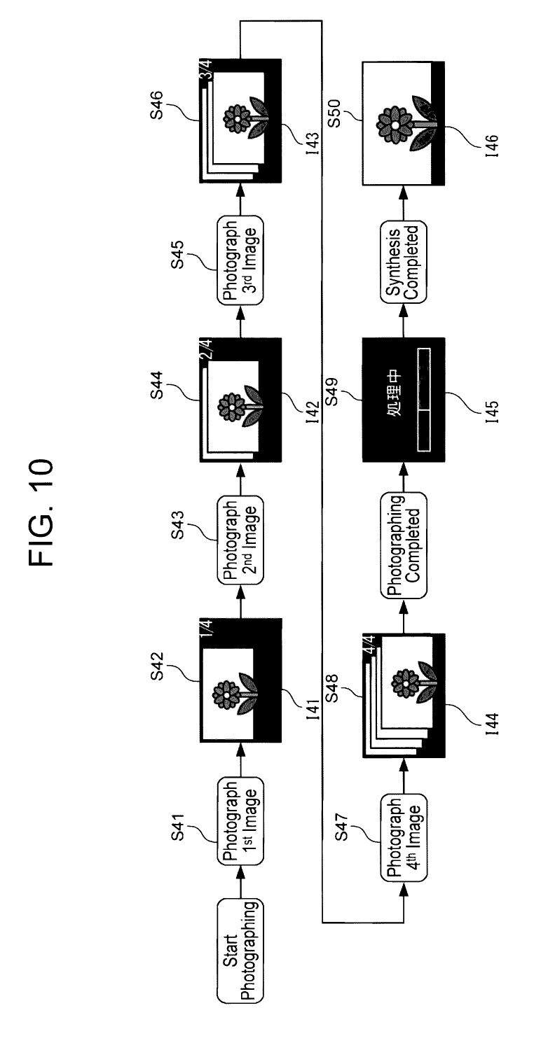

In the digital camera (imaging apparatus) 10 of the third embodiment, the display controller 40C displays the plurality of captured images obtained at the reference position and at the plurality of relative positions on the display screen of the LCD 24 so that the displayed images partially overlap each other at shifted positions relative to a predetermined direction (e.g., in a diagonal direction from the top left toward the bottom right of the screen, as shown in FIG. 10).

For example, the display controller 40C configures the display screen of the LCD 24 so that the plurality of partial screen areas, which respectively correspond to the reference position and the plurality of relative positions, partially overlap each other at shifted positions relative to a predetermined direction. Furthermore, the plurality of captured images obtained at the reference position and the first through third relative positions are sequentially displayed at the plurality of partial screen areas, which correspond to the reference position and the first through third relative positions. Similar to the second embodiment, the display controller 40C can display “information indicating that an image is currently being captured” at the partial screen area that corresponds to either the reference position or one of the relative positions at which an image is currently being captured.

Furthermore, the display controller 40C can display on the display screen of the LCD 24, with each captured image, the number of images to be captured that constitute an image set and the number of captured images that currently have already been obtained.

### [Example Operation of Imaging Apparatus]

The following is a description of an example of a process performed by a digital camera (imaging apparatus) 10 of the third embodiment, which is provided with the above-described configuration. FIG. 10 is an explanatory diagram of the process performed by the digital camera 10 of the third embodiment.

At step S41 (indicated in FIG. 10), the imaging controller 40A controls the photographing of a first image at the reference position (i.e., the position shown in FIG. 5A).

At step S42, upon the photographing operation at the reference position ending, the display controller 40C displays the captured image (developed image) obtained at the reference position on the LCD 24 at the partial screen area thereof that corresponds to the reference position. In this stage, a display image I41 is the image that is displayed on the LCD 24. The display image I41 displays “1/4”, which indicates that the number of images to be captured that constitute an image set is “4”, and that the number of captured images that have currently already been obtained is “1”. At step S43, the imaging controller 40A controls the image sensor 22 and the aforementioned optical element (e.g., the photographing lens group 31) to relatively shift to the first relative position (i.e., the position shown in FIG. 5B), and controls the photographing operation for the second image at the first relative position.

At step S44, upon the photographing operation at the first relative position ending, the display controller 40C further displays the captured image (developed image) obtained at the first relative position on the LCD 24 at the partial screen area thereof that corresponds to the first relative position. As described above, the display screen of the LCD 24 is configured so that the plurality of partial screen areas, which respectively correspond to the reference position and the plurality of relative positions, partially overlap each other at shifted positions relative to a predetermined direction. Therefore, as shown in the display image I42 in FIG. 10, the captured image obtained at the first relative position is shown overlapped onto the captured image obtained at the reference position, except for part of the captured image obtained at the reference position. The display image I42 displays “2/4”, which indicates that the number of images to be captured that constitute an image set is “4”, and that the number of captured images that have currently already been obtained is “2”. At step S45, the imaging controller 40A controls the image sensor 22 and the aforementioned optical element (e.g., the photographing lens group 31) to relatively shift to the second relative position (i.e., the position shown in FIG. 5C), and controls the photographing operation for the third image at the second relative position.

At step S46, upon the photographing operation at the second relative position ending, the display controller 40C further displays the captured image (developed image) obtained at the second relative position on the LCD 24 at the partial screen area thereof that corresponds to the second relative position. As shown in the display image I43 in FIG. 10, the captured image obtained at the second relative position is shown overlapped onto the captured image obtained at the first relative position, except for part of the captured image obtained at the first relative position. The display image I43 displays “3/4”, which indicates that the number of images to be captured that constitute an image set is “4”, and that the number of captured images that have currently already been obtained is “3”. At step S47, the imaging controller 40A controls the image sensor 22 and the aforementioned optical element (e.g., the photographing lens group 31) to relatively shift to the third relative position (i.e., the position shown in FIG. 5D), and controls the photographing operation for the fourth image at the third relative position.

At step S48, upon the photographing operation at the third relative position ending, the display controller 40C further displays the captured image (developed image) obtained at the third relative position on the LCD 24 at the partial screen area thereof that corresponds to the third relative position. As shown in the display image I44 in FIG. 10, the captured image obtained at the third relative position is shown overlapped onto the captured image obtained at the second relative position, except for part of the captured image obtained at the second relative position. The display image I44 displays “4/4”, which indicates that the number of images to be captured that constitute an image set is “4”, and that the number of captured images that have currently already been obtained is “4”. At step S49, the synthesized-image generator 40B generates a synthesized image using the four captured images obtained at the reference position and the first through third relative positions; during this time, the display controller 40C causes a display image I45 to display information indicating that an image-synthesizing operation is in progress on the LCD 24.

At step S50, upon the image-synthesizing operation ending, the display controller 40C displays the generated synthesized image on the LCD 24. For example, as shown in FIG. 10, a display image I46 of the synthesized image is displayed on the LCD 24.

As described above, according to the third embodiment, in the DSP 40 the display controller 40C displays, on the LCD 24, the plurality of captured images obtained at the reference position and at the plurality of relative positions so as to partially overlap each other at shifted positions relative to a predetermined direction (e.g., in a diagonal direction from the top left toward the bottom right of the screen, as shown in FIG. 10).

According to the configuration of the DSP 40, the amount of progress of the imaging process of the multi-shot mode can be reliably recognized by the user.

### Embodiment 4

The fourth embodiment describes a variation in the displaying method of displaying a plurality of captured images obtained at the reference position and at the above-described plurality of relative positions.

### [Example Configuration of Imaging Apparatus]

In the digital camera (imaging apparatus) 10 of the fourth embodiment, the display controller 40C applies “translucent processing” on each of the plurality of captured images obtained at the reference position and at the plurality of relative positions, and the obtained plurality of translucent images are overlaid onto each other and displayed on the LCD 24. The “translucent processing” refers to a process which adjusts the transparency of the captured image and generates a translucent image. In the present embodiment, since it is assumed that four translucent images will be overlaid onto each other, the display controller 40C can set each of the four translucent images to a transparency of 25% (=1/4) so that the sum of transparencies of the four translucent images becomes 100% when overlaid onto each other in sequence. Furthermore, the display controller 40C can display “information indicating that an image is currently being captured” at a fundamental position on the LCD 24 when an image is currently being captured.

For example, the display controller 40C can display the obtained plurality of translucent images on the LCD 24 with the translucent images overlapping each other at shifted positions. Although the amount of shift of the positions at which the translucent images are respectively displayed is not limited to a particular amount, the amount of shift can, e.g., correspond to the above-described “relative shift pattern”. In other words, in the case where the above-described “relative shift pattern” is a pattern that relatively moves at a pitch of 1 pixel, the amount of shift of the display position can be set to “a pitch of 1 pixel”. Alternatively, the amount of shift of the display position can be set to an amount greater than “a pitch of 1 pixel”.

Furthermore, the display controller 40C displays on the display screen of the LCD 24, with each captured image, the number of images to be captured that constitute an image set and the number of captured images that currently have already been obtained.

### [Example Operation of Imaging Apparatus]

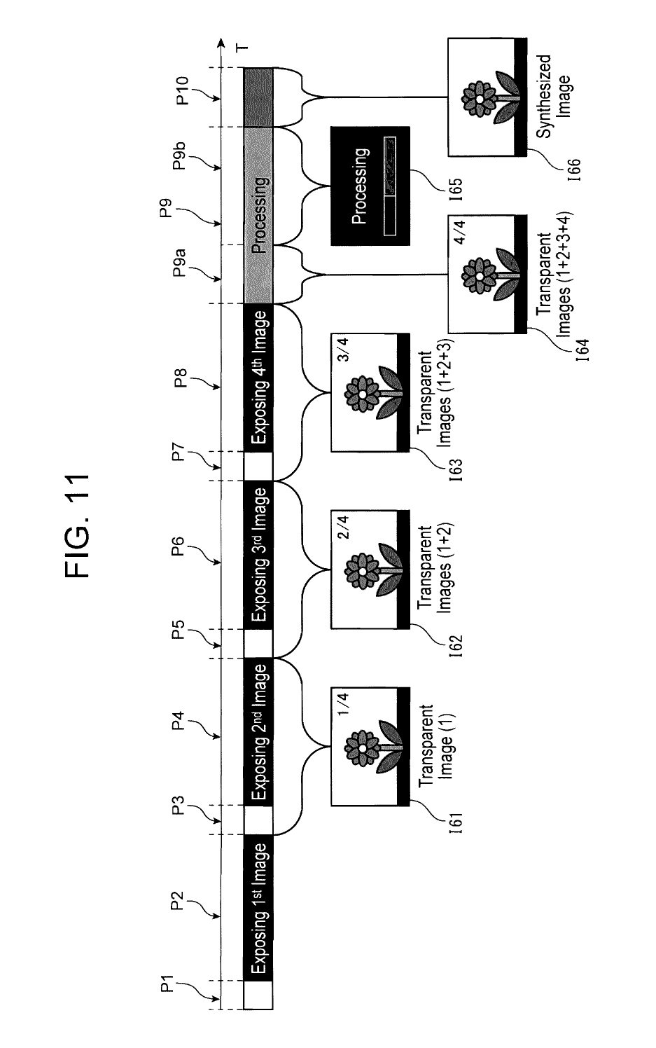

The following is a description of an example of a process performed by a digital camera (imaging apparatus) 10 of the fourth embodiment, which is provided with the above-described configuration. FIG. 11 is an explanatory diagram of the process performed by the digital camera 10 of the fourth embodiment.

At interval P1 (indicated in FIG. 11), the imaging controller 40A of the DSP 40 controls a photographing preliminary operation. At interval P2, the imaging controller 40A controls the photographing of a first image at the reference position (i.e., the position shown in FIG. 5A).

At interval P3, the imaging controller 40A controls the image sensor 22 and the aforementioned optical element (e.g., the photographing lens group 31) to relatively shift to the first relative position (i.e., the position shown in FIG. 5B). At interval P4, the imaging controller 40A controls the photographing operation for the second image at the first relative position. Furthermore, during intervals P3 and P4, the display controller 40C displays a translucent image that corresponds to the reference position on the LCD 24. The image that is displayed at this time is display image I61 (transparent image (1)). The display image I61 displays “1/4”, which indicates that the number of images to be captured that constitute an image set is “4”, and that the number of captured images that have currently already been obtained is “1”.

At interval P5, the imaging controller 40A controls the image sensor 22 and the aforementioned optical element (e.g., the photographing lens group 31) to relatively shift to the second relative position (i.e., the position shown in FIG. 5C). At interval P6, the imaging controller 40A controls the photographing operation for the third image at the second relative position. Furthermore, during intervals P5 and P6, the display controller 40C further displays, on the LCD 24, a translucent image that corresponds to the first relative position while overlaying the aforementioned translucent image that corresponds to the reference position. The image that is displayed at this time is display image I62 (transparent images (1+2)). The display image I62 displays “2/4”, which indicates that the number of images to be captured that constitute an image set is “4”, and that the number of captured images that have currently already been obtained is “2”.

At interval P7, the imaging controller 40A controls the image sensor 22 and the aforementioned optical element (e.g., the photographing lens group 31) to relatively shift to the third relative position (i.e., the position shown in FIG. 5D). At interval P8, the imaging controller 40A controls the photographing operation for the fourth image at the third relative position. Furthermore, during intervals P7 and P8, the display controller 40C further displays, on the LCD 24, a translucent image that corresponds to the second relative position while overlaying the aforementioned translucent image that corresponds to the first relative position. The image that is displayed at this time is display image I63 (transparent images (1+2+3)). The display image I63 displays “3/4”, which indicates that the number of images to be captured that constitute an image set is “4”, and that the number of captured images that have currently already been obtained is “3”.

At interval P9, the synthesized-image generator 40B carries out a image-synthesizing operation. Furthermore, during interval P9a, the display controller 40C further displays, on the LCD 24, a translucent image that corresponds to the third relative position while overlaying the aforementioned translucent image that corresponds to the second relative position. The image that is displayed at this time is display image I64 (transparent images (1+2+3+4)). At interval P9b, the display controller 40C displays on the LCD 24 information indicating that an image-synthesizing operation is in progress; the image that is displayed during this time is display image I65. The display image I64 displays “4/4”, which indicates that the number of images to be captured that constitute an image set is “4”, and that the number of captured images that have currently already been obtained is “4”.

At interval P10, the display controller 40C displays the generated synthesized image on the LCD 24; the image that is displayed during this time is display image I66.

As described above, according to the fourth embodiment, in the DSP 40 the display controller 40C displays, on the LCD 24, the plurality of translucent images, obtained by applying translucent processing on the plurality of captured images at the reference position and at the plurality of relative positions, while overlaying the plurality of translucent images onto each other.

According to the configuration of the DSP 40, the amount of progress of the imaging process of the multi-shot mode can be reliably recognized by the user.

The amount of shift of the positions at which the translucent images are respectively displayed can, e.g., correspond to the above-described “relative shift pattern”.

According to the above-described configuration of the DSP 40, in an arrangement in which the progress matches the movement of the multi-shot operation, the amount of progress of the imaging process of the multi-shot mode can be reliably recognized by the user.

Furthermore, the amount of shift of the positions at which the translucent images are respectively displayed can, e.g., be greater than the relative movement pitch of the above-described “relative shift pattern”.

According to the above-described configuration of the DSP 40, the amount of progress of the imaging process of the multi-shot mode can be more easily recognized by the user.

### Other Modified Embodiments

[1] Each of the first through fourth embodiments discuss an example in which four photographing images, which are taken (imaged) in the PSR photographing mode (PSR photographing process) by driving (moving) the image sensor 22 in a square movement path at a pitch of one pixel in a plane orthogonal to the optical axis, are designated as a “set of images configured of a plurality of captured images”. However, various design changes are possible since there is a certain degree of freedom in regard to the movement path and pitch by which the image sensor 22 is driven (moved), and also in regard to the number of images of the “set of images configured of a plurality of captured images”, and as to how these images are displayed. For example, as described in the first through fourth embodiments, a split-screen display of the images that constitute the set of images can be carried out, or the images that constitute the set of images can be sequentially displayed in a repeated manner. Furthermore, the direction in which the image sensor 22 is driven (moved) is not limited to within a plane that is orthogonal to the optical axis of the photographing optical system, so long as the driving (movement) direction of the image sensor 22 is different to that of the optical axis of the photographing optical system. In addition, the “set of images configured of a plurality of captured images” are not limited to images that are obtained (photographed/imaged) in the PSR photographing mode, so long as the images have been photographed (imaged) in succession while a change (s) has occurred in the photographing condition (s) of the same object (subject).

[2] In the first through fourth embodiments, the image sensor 22 is described as a “movable member” that is configured to drive (move) within a plane that is orthogonal to the optical axis; however, the present invention is not limited thereto. For example, a configuration is possible in which an optical element constituting at least a part of the photographing lens group (photographing optical system) 31 can be used as a “movable member” which is driven (moved) in a plane that is orthogonal to the optical axis by a voice coil motor provided in the photographing lens 30. Alternatively, a configuration is possible in which an optical element that includes at least part of both the image sensor 22 and the photographing lens group 31 is used as a “movable member” that is driven (moved) within a plane that is orthogonal to the optical axis.

[3] Although the first through fourth embodiments were described on the premise that each captured image of the set of images are displayed on the LCD 24, the present invention is not limited thereto. For example, instead of displaying each captured image on the LCD 24, it is possible to only display the information indicating the number of captured images that have currently already been obtained, display information indicating both the number of images to be captured that constitute an image set and the number of captured images that have currently already been obtained, or display information indicating the sequential order of the position (out of the reference position and the plurality of positions) of the image currently being captured, in accordance with the relative shift. In other words, information (such as an indicator mark) on the amount of progress of the imaging process of the multi-shot mode that can be reliably recognized by the user can be displayed. The method of displaying such information can, for example, be carried out in a predetermined “fixed” manner throughout each of the aforementioned intervals P1 through P9a, or can be only carried out at a timing (e.g., during interval P3 and a first segment of interval P4) at which a captured image cannot be displayed in time, due to the image processing not being able to keep up with the relative-shifting speed. In the latter case, the captured image is displayed at the point in time when the image processing ends. Even if such displaying methods are used, and even if an electronic shutter is used in the image processing of multi-shot mode, the user can recognize when the capturing of one set of images has started and ended. Accordingly, possibility of the user mistakenly moving the imaging apparatus while one set of images (a plurality of captured images) is currently being taken (imaged) is greatly reduced, so that the image quality of the one set of captured images, and in turn the synthesized images, can be improved.

[4] In the first through fourth embodiments, although the DSP 40 and the image sensor drive circuit 60 are portrayed as separate components (blocks), it is also possible to configure these components as a single component (block).

[5] In the first through fourth embodiments, although an example of a configuration of the image-shake correction device 50 is described in which the magnets M1, M2 and M3 and the yokes Y1, Y2 and Y3 are fixed onto the mount support plate 51, and the drive coils C1, C2 and C3 are fixed onto the movable stage 52; a reversed positional relationship is possible in which magnets and yokes are fixed onto a movable stage, and drive coils are fixed onto a mount support plate.

[6] In the first through fourth embodiments, although an example in which the camera body 20 and the photographing lens 30 are detachably attached to each other (lens interchangeable) has been discussed, a configuration in which the camera body 20 and the photographing lens 30 are not detachable (non lens interchangeable) is also possible.

[7] In the first through fourth embodiments, although an example is given in which the imaging apparatus of the present invention is applied to a so-called mirrorless digital camera, the present invention is not limited thereto, the imaging apparatus can be an SLR digital camera provided with a movable mirror (quick-return mirror). In the case where the technology disclosed in the first through fourth embodiments is applied to an SLR digital camera, when (or before) the preliminary photographing operation is carried out at the reference position, the movable mirror is moved up from a viewing position to a ready-to-photograph position and the shutter is fully opened, and thereafter in this state, a first photographing image at the reference position is captured (photographed) followed by three photographing images at the relative positions being captured. When all photographing images have been captured, or thereafter, the shutter is fully closed and the movable mirror is moved (returned) down to the viewing position. According to this modified embodiment, the commencement of photography is recognized either by an ON-command of a mirror-up operation or a shutter operation ON-command, and thereafter, the commencement of photography is recognized by the same display arrangement on the LCD 24 as that of each of the first through fourth embodiments.

Although the digital camera 10 has been described herein as a photographing apparatus/imaging apparatus to which the present invention is applied, the present invention can also be applied to any device which includes a lens system, an image sensor and an image processor, for example: a smart device that is provided with an in-built digital camera (photographing apparatus/imaging apparatus) such as a smart phone or a tablet computer, or a video camera that is capable of taking a plurality of still images (pictures).

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A photographing apparatus comprising:
an image sensor configured to convert an object image formed by a photographing optical system, of said photographing apparatus, into electrical pixel signals, said photographing optical system including an optical element;
an imaging controller configured to control an image-capturing process, in which an image set of a plurality of captured images for use in an image-synthesizing operation are captured, wherein, during said image-capturing process, at least one of said image sensor and said optical element is moved to change a relative position between said image sensor and said optical element; and
a display controller configured to display the captured images of said image set on a display in accordance with the movement of said at least one of said image sensor and said optical element.

2. The photographing apparatus according to claim 1, wherein said imaging controller sequentially moves one of said image sensor and said optical element, in a direction that is different to a direction of the optical axis, from a reference position to a plurality of different relative positions, relative to the other of said image sensor and said optical element.

3. The photographing apparatus according to claim 1, wherein said display controller displays, on said display, a number of images to be captured that constitute said image set and a number of captured images that have currently already been obtained with each said captured images of said image set.

4. The photographing apparatus according to claim 3, wherein said display controller defines a plurality of partial screen areas on a display screen of said display, and displays said plurality of captured images, obtained at said reference position and at said plurality of different relative positions, at said plurality of partial screen areas, respectively, which correspond to said reference position and said plurality of different relative positions.

5. The photographing apparatus according to claim 4, wherein said display controller displays information indicating that an image is currently being captured at the partial screen area that corresponds to one of the reference position and the relative positions at which said image is currently being captured.

6. The photographing apparatus according to claim 4, wherein said display controller displays, at a timing during which said synthesized image is being generated, an animation which shows said plurality of captured images that are respectively displayed at said plurality of partial screen areas consolidating and synthesizing at a predetermined area of said display screen.

7. The photographing apparatus according to claim 1, wherein said display controller displays said plurality of captured images on said display in a display pattern that corresponds to a pattern of said movement of said at least one of said image sensor and said optical element.

8. The photographing apparatus according to claim 3, wherein said display controller displays, on said display screen. of said display, said plurality of captured images obtained at said reference position and at said plurality of relative positions, so as to partially overlap each other at shifted positions relative to one direction.

9. The photographing apparatus according to claim 3, wherein said display controller displays, on said display screen of said display, a plurality of translucent images obtained by applying translucent processing on said plurality of captured images obtained at said reference position and at said plurality of relative positions, while overlaying said plurality of translucent images onto each other.

10. The photographing apparatus according to claim 9, wherein said display controller displays, on said display screen of said display, the obtained said plurality of translucent images so as to overlap each other at shifted positions.

11. The photographing apparatus according claim 2, further comprising a plurality of color filters, including a basic unit of one R pixel, two G pixels and one B pixel, for use in said image-capturing process,
wherein each of said reference position and said plurality of relative positions correspond to each pixel of said basic unit.

12. A photographing controller, by which an image set of a plurality of captured images for use in an image-synthesizing operation are captured in a photographing apparatus, whereby at least one of an image sensor and an optical element of said photographing apparatus is moved to change a relative position between said image sensor and said optical element, said photographing controller comprising:
a display controller configured to display, on a display screen of a display, said image set of said plurality of captured images in accordance with the movement of said at least one of said image sensor and said optical element.

13. A photographing control method, by which an image set of a plurality of captured images for use in an image-synthesizing operation are captured in a photographing apparatus, whereby at least one of an image sensor and an optical element of said photographing apparatus is moved to change a relative position between said image sensor and said optical element, said photographing control method comprising:
displaying, on a display screen of a display, said image set of said plurality of captured images in accordance with the movement of said at least one of said image sensor and said optical element.

14. A photographing control program, to be implemented by a processor, which performs a process which displays, on a display screen of a display, an image set of a plurality of captured images for use in an image-synthesizing operation in accordance with a movement of at least one of an image sensor and an optical element provided in a photographing apparatus, while changing a relative position between said image sensor and said optical element.
